(19) United States
(12) Patent Application Publication
(10) Pub. No.: US 2007/0158865 A1
(43) Pub. Date: Jul. 12, 2007

(54) Method for producing contact lenses

(76) Inventors: Todd Aldridge Russell, Grayson, GA (US); Yasuo Matsuzawa, Roswell, GA (US)

Correspondence Address: CIBA VISION CORPORATION;PATENT DEPARTMENT, 11460 JOHNS CREEK PARKWAY, DULUTH, GA, 30097-1556, US

(21) Appl. No.: 11/643,267

(22) Filed: Dec. 21, 2006

Related U.S. Application Data
(60) Provisional application No. 60/754,118, filed on Dec. 27, 2005.

(51) Int. Cl. B29D 11/00

(52) U.S. Cl. 264/1.1; 425/808

(57) ABSTRACT

The invention provides an improved process for manufacturing silicone-hydrogel contact lenses. The improvement includes use of a vacuum force to transport lens molds to and from a hot water deblocking process.

This application claims the benefit under 35 U.S.C. § 119 (e) of U.S. provisional application Ser. No. 60/754,118 filed Dec. 27, 2005.

The present invention is related to an improved method for producing contact lenses, in particular silicone hydrogel contact lenses.

### BACKGROUND OF THE INVENTION

In recent years, silicone hydrogel contact lenses, for example, Focus NIGHT & DAY™ and O₂OPTIX™ (both from CIBA VISION), have become more and more popular because of corneal health benefits provided by their high oxygen permeability and comfort.

Silicone hydrogel contact lenses can be manufactured economically in large numbers by a conventional full-mold process involving disposable molds, the examples of which are disclosed in, for example, PCT patent application no. WO/87/04390, in EP-A 0 367 513, or in U.S. Pat. No. 5,894,002. In a conventional molding process, a predetermined amount of a polymerizable or crosslinkable material typically is introduced into a disposable mold comprising a female (concave) mold half and a male (convex) mold half. The female and male mold halves cooperate with each other to form a mold cavity having a desired geometry for a contact lens. Normally, a surplus of polymerizable or crosslinkable material is used so that when the male and female halves of the mold are closed, the excess amount of the material is expelled out into an overflow area adjacent to the mold cavity. The polymerizable or crosslinkable material remaining within the mold is polymerized or cross-linked by means of actinic radiation (e.g., UV irradiation, ionized radiation, microwave irradiation) or by means of heating. The starting material in the mold cavity is cured to form a lens while the excess material in the overflow area is partially or completely cured to form flash. After curing, the mold is separated into the male and female mold halves with the formed lens adhered onto either male or female mold half.

After mold separation, the lens on its respective mold half (male or female) together is subjected to extraction with an organic solvent (e.g., IPA (isopropyl alcohol)). This is done because the lens is difficult to be removed from the mold half due to a strong adhesion between the lens and the mold half. It is believed that this strong adhesion is due to the tackiness of the surface of a silicone hydrogel lens so produced. If the lens is removed from the mold half by force, the lens can adhere to itself (curl) and lens handling can be difficult and/or the lens can be damaged.

After the extraction, the lens, still on the mold half, is equilibrated in water and then removed from the mold half. However, the lens still adheres onto the mold surface, thus, a solvent mixture is used to deblock (or dislodge) the lens. The removed lens is further subjected to other process, such as, for example, plasma treatment, hydration, sterilization, etc.

In general, extraction and equilibration of lenses are carried out in batch processes. There are some disadvantages associated with each lens associated with one mold half. First, mold halves take up valuable space in an extraction or equilibration tank and therefore reduce the capacity of extraction which can be carried out in each tank. Second, lens flash can be partially or completely dissolved in an extraction bath. Any dissolution of lens flash can potentially reduce extraction efficiency. Third, lens flash may be still attached to the lens even after extraction and equilibration. Any lens with flash attached thereto will be rejected and as such, production yield can be decreased. It would be desirable to have a step of removing, also known as “deblocking” or “dislodging”, the lens from the lens-adhering mold half. One method to deblock or dislodge the lens is to expose the newly cured mold and lens to hot water. Unfortunately, very hot water affects the ability of gripper devices to transport the molds to and from the hot water source

Therefore, it would be beneficial to provide an improved process in which each lens is transported to and from a hot water deblocking process.

### SUMMARY OF THE INVENTION

In one aspect, the invention provides a method for producing contact lenses. The method comprises: providing a mold including a male mold half having a first molding surface and a female mold half having a second molding surface, wherein the male and female mold halves are configured to receive each other such that a mold cavity is formed between the first and second molding surfaces when the mold is closed; dispensing a specific amount of a silicone hydrogel lens-forming material into one of the male and female mold halves; mating the male and female mold halves to close the mold; curing the silicone hydrogel lens-forming material located between the two mold halves, thereby forming a molded silicone hydrogel contact lens; separating the mold into the male and female mold halves, with the silicone hydrogel contact lens adhered on one of the male and female mold halves; transferring the molds to a hot water source, placing the molds in a hot water source so as to reduce adhesion between the lens and the lens-adhering mold half; and removing the lens from the lens-adhering mold half and placing the lens in a tray for further processing.

This invention improves upon prior art (i.e. vacuum generators & pumps because the syringe vacuum is able to handle vacuum applications involving water and/or moisture—previous ejectors & vacuum pumps typically accumulate water over time and eventually cease operation. Additionally, the present invention reduces operating costs (no constant supply of air or electricity required for operation in the case of an ejector or pump, respectively) substantially. The simple, elegant design of the present invention also reduces equipment costs because plastic syringes & air cylinders readily available in various sizes at substantially less cost & complexity as compared to vacuum ejectors, pumps, etc.

Although the present invention may be used for handling light weight polypropylene contact lens molds in a wet environment, the device is capable of adaptation to include most all vacuum applications traditionally solved by ejectors & pumps. In addition, this device will handle non-traditional vacuum applications involving the presence of liquids where conventional vacuum systems would otherwise fail.

The present invention provides the foregoing and other features, and the advantages of the invention will become further apparent from the following detailed description of the presently preferred embodiments, read in conjunction with the accompanying figures. The detailed description and figures are merely illustrative of the invention and do not limit the scope of the invention, which is defined by the appended claims and equivalents thereof.

### DESCRIPTION OF THE DRAWINGS

FIG. 1 is a front view of the servo subassembly of the present invention

FIG. 2 is a side view of the servo subassembly of FIG. 1 in conjunction with a dip tank and an extraction tray

FIG. 3 is a front view of the servo subassembly of FIG. 1, in which end-of-arm tooling (EOAT) is extended.

### DESCRIPTION OF PREFERRED EMBODIMENTS

Reference now will be made in detail to the embodiments of the invention, one or more examples of which are set forth below. Each example is provided by way of explanation of the invention, not by limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term.

A “hydrogel” refers to a polymeric material which can absorb at least 10 percent by weight of water when it is fully hydrated. Generally, a hydrogel material is obtained by polymerization or copolymerization of at least one hydrophilic monomer in the presence of or in the absence of additional monomers and/or macromers.

A “silicone hydrogel” refers to a hydrogel obtained by copolymerization of a polymerizable composition comprising at least one silicone-containing monomer or at least one silicone-containing macromer.

A “monomer” means a low molecular weight compound that comprises one or more crosslinkable groups and can be crosslinked and/or polymerized actinically or thermally or chemically to obtain a crosslinked and/or polymerized polymer. As used herein, “actinically” in reference to curing or polymerizing of a polymerizable composition or material means that the curing (e.g., crosslinked and/or polymerized) is performed by actinic irradiation, such as, for example, UV irradiation, ionized radiation (e.g. gamma ray or X-ray irradiation), microwave irradiation, and the like. Thermal curing or actinic curing methods are well-known to a person skilled in the art.

A “macromer” refers to a medium and high molecular weight compound or polymer that contains functional groups capable of undergoing further polymerizing/crosslinking reactions. Medium and high molecular weight typically means average molecular weights greater than 700 Daltons. Preferably, a macromer contains ethylenically unsaturated groups and can be polymerized actinically or thermally.

A “polymer” means a material formed by polymerizing/crosslinking one or more monomers, macromers and or oligomers.

“Molecular weight” of a polymeric material (including monomeric or macromeric materials), as used herein, refers to the number-average molecular weight unless otherwise specifically noted or unless testing conditions indicate otherwise.

A “prepolymer” refers to a starting polymer which can be cured (e.g., crosslinked and/or polymerized) actinically or thermally or chemically to obtain a crosslinked and/or polymerized polymer having a molecular weight much higher than the starting polymer. A “actinically crosslinkable prepolymer” refers to a starting polymer which can be crosslinked upon actinic radiation to obtain a crosslinked polymer having a molecular weight much higher than the starting polymer.

A “lens-forming material” refers to a polymerizable composition which can be cured (i.e., polymerized and/or crosslinked) thermally or actinically or chemically to obtain a crosslinked polymer. Lens-forming materials are well known to a person skilled in the art. In accordance with the invention, a lens-forming material comprises at least one silicon-containing monomer or macromer, or can be any lens formulations for making soft contact lenses. Exemplary lens formulations include without limitation the formulations of lotrafilcon A, lotrafilcon B, etafilcon A, genfilcon A, lenefilcon A, polymacon, acquafilcon A, balafilcon, senofilcon A, and the like. A lens-forming material can further include other components, such as an initiator (e.g., a photoinitiator or a thermal initiator), a visibility tinting agent, UV-blocking agent, photosensitizers, and the like. Preferably, a silicone hydrogel lens-forming material used in the present invention comprises a silicone-containing macromer.

The invention is generally related to a method for transporting molds and lenses after a hot water deblocking process by using vacuum force.

Methods of manufacturing mold sections for cast-molding a contact lens are generally well known to those of ordinary skill in the art. The process of the present invention is not limited to any particular method of forming a mold. In fact, any method of forming a mold can be used in the present invention. However, for illustrative purposes, the following discussion has been provided as one embodiment of forming a mold.

In general, a mold comprises at least two mold sections (or portions) or mold halves, i.e. male and female mold halves. The male mold half defines a first molding (or optical) surface defining the posterior (concave) surface of a lens and the second mold half defines a second molding (or optical) surface defining the anterior (convex) surface of a lens. The first and second mold halves are configured to receive each other such that a lens forming cavity is formed between the first molding surface and the second molding surface. The molding surface of a mold half is the cavity-forming surface of the mold and in direct contact with lens-forming material.

The first and second mold halves can be formed through various techniques, such as injection molding. These half sections can later be joined together such that a cavity forms therebetween. Thereafter, a contact lens can be formed within the cavity of the mold sections using various processing techniques, such as actinic or thermal curing. Examples of suitable processes for forming the mold halves are disclosed in U.S. Pat. Nos. 4,444,711 to Schad; 4,460,534 to Boehm et al.; 5,843,346 to Morrill; and 5,894,002 to Boneberger et al., which are also incorporated herein by reference.

Virtually all materials known in the art for making molds can be used to make molds for making contact lenses. For example, polymeric materials, such as polyethylene, polypropylene, and PMMA can be used. Other materials that allow UV light transmission could be used, such as quartz glass.

Preferably, one of the female and male mold halves is subjected to a surface treatment, such as, for example, a corona treatment or a plasma treatment or the like, prior to its use in order for the molded contact lens to adhere preferentially to one particular mold half when opening the mold. Such pre-treatment is described in U.S. Patent No. 5,894,002, herein incorporated by reference in its entirety.

A specific amount of a polymerizable lens-forming material is typically dispensed into a female mold half by means of a dispensing device and then a male mold half is put on and the mold is closed. As the mold closes, any excess unpolymerized lens-forming material is pressed into an overflow provided on the female mold half (or alternatively on the male mold halo.

Subsequently, the closed mold containing the polymerizable lens-forming material is cured. A person skilled in the art knows well how to cure a lens-forming material. For example, a lens-forming material is subjected to actinic irradiation (e.g., UV radiation) at least in the region of the lens forming cavity or thermal treatment (e.g., heating in an oven) to form a lens. For actinic curing, at least one of the mold halves is transparent to the actinic radiation (e.g., UV light) at least in the region of the molding surface. Thus, at least the polymerizable lens-forming material in the lens forming cavity is polymerized. It is also possible for any polymerizable lens-forming material in the overflow to be polymerized. This is advantageous in the respect that, when the mold is opened, the excess polymerized lens-forming material then remains in the overflow of the female mold half, while the contact lens adhering to the male mold half can be removed and further processed together with male mold half.

Subsequently, the mold is opened, preferably by an apparatus described in a copending patent application entitled “Method for producing contact lenses” filed on Mar. 20, 2005 (herein incorporated by reference in its entirety). A mold is separated into a male mold half and a female mold half, with the molded lens adhered to one of the two mold halves. After the molds are separated, hot water is dispensed over the lens and/or in the lens-adhering mold half and then is allowed to penetrate into interface between the lens and the lens-adhering mold half so as to reduce adhesion between the lens and the lens-adhering mold half, as described in the U.S. Patent Application filed Mar. 9, 2005 entitled “Method for Producing Contact Lenses,” which is expressly incorporated by reference as if fully set forth herein.

Because the temperature of the water is higher than about 60° C., preferably higher than about 70° C., more preferably higher than about 80° C., even more preferably from about 90° C. to about 100° C., traditional methods, such as 3-finger mechanical gripper or tweezer—type apparatus, for removing the molds may fail.

According to the present invention a vacuum system may be used to expose the molds to and remove the molds from a hot water source, such as for example a hot water dip tank.

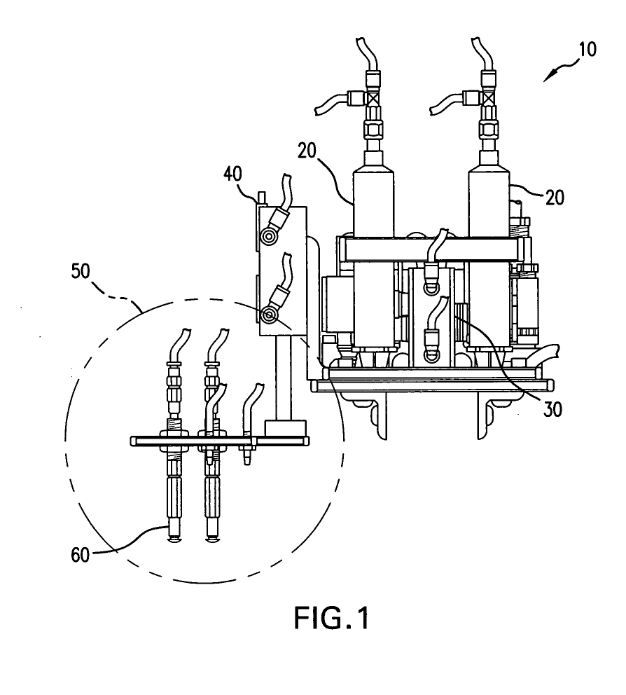

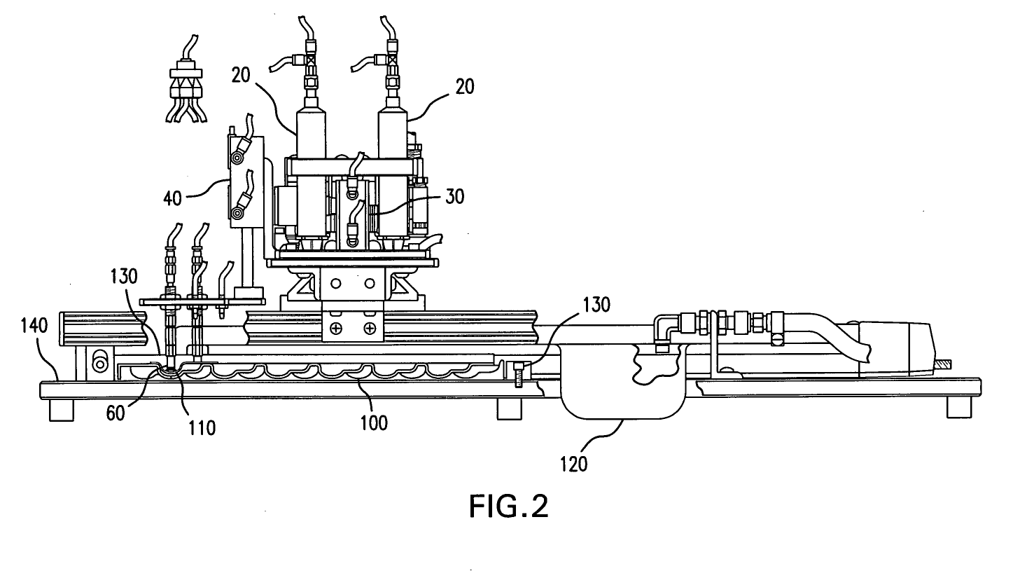

An exemplary vacuum system may include plastic syringes coupled to a mechanical actuator to generate and maintain a vacuum. In one embodiment of the present invention, the mechanical actuator may be an air cylinder. An assembly of the present invention is shown in FIG. 1. FIG. 1 depicts a servo subassembly 10. Subassembly 10 may include syringes 20, vacuum cylinder 30, z-axis cylinder 40, a pick and place (p&p) head 50, and end of arm tooling (EOAT) 60. FIG. 2 shows subassembly 10 in place with other components. Subassembly 10 preferably may be positioned over an extraction tray 100 and/or a dip tank 120 and is adapted to move between extraction tray 100 and dip tank 120. Extraction tray 100 contains mold halves 110 and may contain wells for front curve or base curve molds.

Referring again to FIG. 2, more specifically, after curing but before exposure to hot water, subassembly 10 is positioned over the mold halves 110. Before such action, the molds halves 110 are preferably in an extraction tray 100 that is located in a specific position, such that end of arm tooling (EOAT) may properly orient over mold halves 110. In one embodiment of the present invention, proper positioning may be ensured my using one or more tray stops 130. Next, the z-axis cylinder 40 lowers the p&p head 50 of subassembly 10 so that the end of arm tooling (EOAT) 60 is in contact with mold halves 110. Once contact is made, a vacuum cylinder 30 preferably extends to generate vacuum force via the syringes 20, thereby capturing the mold halves 110 via the EOAT 60. The Z-axis cylinder 40, which controls the p&p head 50 is then preferably retracted with the mold halves 110 now intact.

Once servo subassembly 10 is positioned over dip tank 120 with mold halves 110, Z-axis cylinder 40 lowers mold halves 110 into the dip tank 120 for an appropriate period of time. In one embodiment of the invention, mold halves 110 may be dipped into the tank for approximately 2-5 seconds. In another embodiment, mold halves 110 may be dipped for approximately 3 seconds. In one embodiment of the present invention, the dip tank water level and temperature may be controlled by a recirculating hot water bath (not shown) that maintains water temperature at a predetermined setpoint. In this embodiment, the bath may automatically monitor the water level throughout the system and will automatically refill water when needed.

After the molds have been in the bath for the proper amount of time, the z-axis cylinder 40 preferably raises the mold halves 110 from the dip tank 120 and the servo subassembly 10 transports them back to their original position in the extraction tray 100.

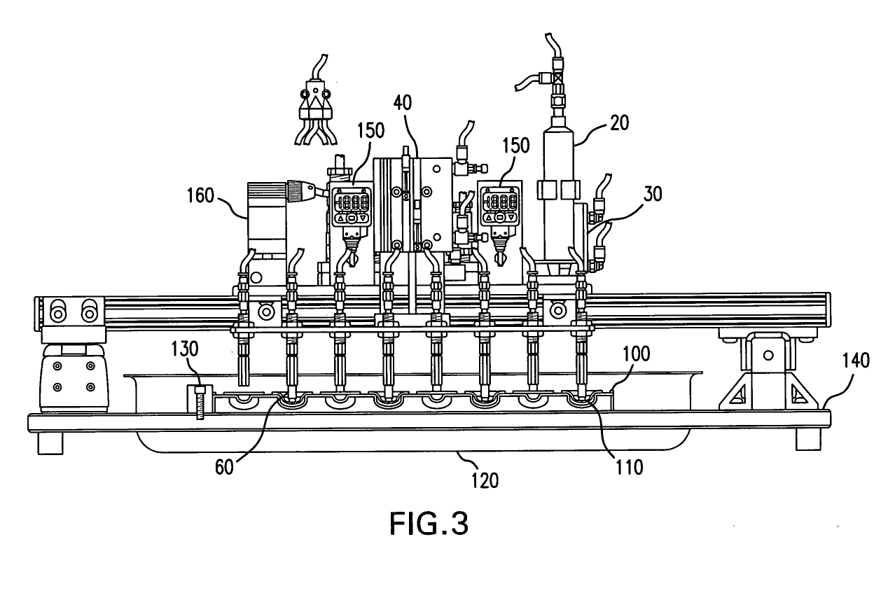

Referring to FIG. 3, after the mold halves 110 are captured by the EOAT 60, z-axis cylinder 40 preferably lowers mold halves 110 back into positions and releases them to the extraction tray 100.

In some embodiments of the present invention, particularly when base curve mold halves are used, dispense valves 160, shown in FIG. 3, may deposit a small amount of water into each of the extraction tray wells while the p&p head 50 is in the down position. This procedure keeps the lenses hydrated while the deblocking operation proceeds for subsequent lenses. Front curve molding does not require this additional step, as the mold half serves as a cup to hold an amount of water against the lens following the dip process.

In one embodiment of the present invention, part presence may be checked via vacuum switches 150 that measure the generated vacuum level. If the vacuum level is sufficient, signifying that part pickup was successful, the servo subassembly preferably moves to a dip tank. Part presence may be checked again via vacuum switches 150 after the dip operation to ensure the mold halves 110 remain captured by the EOAT 60. Specifically, part (mold half) presence may be checked by measuring the generated vacuum level with vacuum switches 150 (shown in FIG. 3). If the vacuum level is sufficient (i.e. parts captured), the servo subassembly 10 moves to dip tank 120. If the vacuum level is not sufficient, the z axis cylinder 40 lowers the p&p head 50, releases the vacuum (and therefore the mold halves 110) by retracting vacuum cylinder 30 and the z axis cylinder 40 retracts. Operation may be suspended until an operator can determine and correct the problem.

In accordance with the invention, after dislodging from the mold half, the lens is placed in a tray for further processing, such as, for example, extraction, hydration, etc. As used herein, a tray is intended to describe a device which can hold a plurality of contact lenses and used in lens processing, such as, for example, extraction, hydration, equilibration. Any trays or equivalents can be used in the invention. Preferred trays are those described in a U.S. patent application Ser. No. 10/152,930 filed May 22, 2002 (here incorporated by reference in its entirety).

It is understood that a method of the invention can be performed manually or automatically under control of a computer. A person skilled in the art known how to automate a method of the invention.

It is also understood that a silicone-hydrogel lens so produced can further subject other lens manufacturing processes, such as for example, surface treatment, sterilization, and the like.

Although various embodiments of the invention have been described using specific terms, devices, and methods, such description is for illustrative purposes only. The words used are words of description rather than of limitation. It is to be understood that changes and variations may be made by those skilled in the art without departing from the spirit or scope of the present invention, which is set forth in the following claims. In addition, it should be understood that aspects of the various embodiments may be interchanged either in whole or in part. Therefore, the spirit and scope of the appended claims should not be limited to the description of the preferred versions contained therein.

What is claimed is:

1. A method for producing contact lenses, comprising the steps of:
a) providing a mold including a male mold half having a first molding surface and a female mold half having a second molding surface, wherein the male and female mold halves are configured to receive each other such that a mold cavity is formed between the first and second molding surfaces when the mold is closed;
b) dispensing a specific amount of a silicone hydrogel lens-forming material into one of the male and female mold halves;
c) mating the male and female mold halves to close the mold;
d) curing the silicone hydrogel lens-forming material located between the two mold halves, thereby forming a molded silicone hydrogel contact lens;
e) separating the mold into the male and female mold halves, with the silicone hydrogel contact lens adhered on one of the male and female mold halves;
f) transporting the mold halves to and from a reservoir containing water with a temperature above 59 degrees C using a servo subassembly

2. The method of claim 1, wherein the hot water has a temperature of higher than about 80° C.

3. The method of claim 6, wherein the hot water has a temperature of from about 90° C. to about 100° C.

4. The method of claim 1, wherein said servo subassembly further comprises
at least one syringe; and
at least one vacuum cylinder ,wherein said vacuum cylinder is in fluid connection with said syringe and extends to generate a vacuum force via said syringes.

5. The method of claim 4, wherein said servo subassembly further comprises
at least one vacuum switch designed to measure said vacuum force;
at least one z-axis cylinder attached to a pick and place head; and
at least one pick and place head attached to end of arm tooling.

6. The method of claim 5, further comprising a dispense valve adapted to dispense fluid into an extraction tray well.

7. The method of claim 1, wherein said method is adapted to be used in high moisture or wet environments.

8. A vacuum system for the transport of mold halves comprising:
at least one syringe;
at least one vacuum cylinder wherein said vacuum cylinder is in fluid connection with said syringe and extends to generate a vacuum force via said syringes;
at least one z-axis cylinder attached to a pick and place head; and
at least one pick and place head attached to end of arm tooling.

9. The system of claim 8, wherein said mold halves are transported from an extraction tray well to a hot water source and back to said extraction tray.

10. The system of claim 8, further comprising vacuum switches that are adapted to measure the generated vacuum force.

11. The system of claim 9, wherein said end of arm tooling contacts the mold halves and via vacuum force moves the mold halves to and from a hot water source.

12. The system of claim 8, wherein said method is adapted to be used in high moisture or wet environments.
